(19) United States
(12) Patent Application Publication
(10) Pub. No.: US 2009/0267721 A1
(43) Pub. Date: Oct. 29, 2009

(54) COIL UNIT AND ELECTRONIC APPARATUS USING THE SAME

(75) Inventors: Hirofumi Okada, Suwa-shi (JP); Mikimoto Jin, Chino-shi (JP); Kentaro Yoda, Chino-shi (JP); Takahiro Kamijo, Fujimi-cho (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/428,199

(22) Filed: Apr. 22, 2009

(30) Foreign Application Priority Data
Apr. 25, 2008 (JP) 2008-114846

(51) Int. Cl. H01F 27/28

(52) U.S. Cl. 336/232

(57) ABSTRACT

A coil unit includes a coil and a magnetic substance for receiving magnetic force lines generated by the coil, the magnetic substance including a first magnetic substance having a first magnetic permeability and a second magnetic substance having a second magnetic permeability.

### CROSS-REFERENCE TO RELATED APPLICATION

This application claims priority to JP2008-114846 filed in Japan on Apr. 25, 2008, the entire disclosure of which is hereby incorporated by reference in its entirety.

### BACKGROUND

1. Technical Field

The present invention relates to a coil unit suitable for contactless power transmission and an electronic apparatus or the like using the coil unit.

2. Related Art

There is known contactless power transmission that uses electromagnetic induction to transmit power without using a metal contact. As applications of contactless power transmission, charging of a cell phone, charging of a home appliance (for example, a cordless handset), and the like have been proposed.

A related-art example of contactless power transmission is disclosed in JP-A-2006-60909. In JP-A-2006-60909, a resonant capacitor connected to the output of a power transmission driver and a primary coil constitute a series resonant circuit and a power transmission unit primary) provides power to a power reception unit (secondary).

In recent years, cell phones are required to be downsized further. For this reason, a coil unit for transmitting power must also be further downsized, particularly, in the thickness dimension.

The characteristics of a coil unit including a coil and a magnetic substance for forming a magnetic path for the coil are evaluated using the Q value, inductance, equivalent resistance, or the like of the coil. The Q value of the coil is proportional to the ratio (L/R) of the inductance (L) of the coil to the equivalent resistance (R) thereof. As the inductance (L) of the coil is increased or as the equivalent resistance (R) thereof is reduced, the Q value thereof is increased.

If the coil unit is downsized or thin-sized, the characteristics of the coil unit must be set to design values. A magnetic substance is typically used to increase the inductance of a coil. The characteristics of the coil unit are determined by the coil and magnetic substance; therefore, if the magnetic substance is constant, the characteristics are changed only by the wire diameter of a coil wire or the number of turns thereof. A change in the number of turns or the wire diameter significantly affects downsizing or reducing the thickness of the coil unit.

### SUMMARY

An advantage of the invention is to provide a coil unit that is allowed to increase the degree of freedom in choosing the characteristics even if the number of turns of a coil or the wire diameter thereof is set in a given range, so that the characteristics are easily set to design values, and an electronic apparatus using the coil unit.

A coil unit according to an aspect of the invention includes a coil and a magnetic substance for forming a magnetic path for the coil. The magnetic substance is a multilayer body including first and second magnetic substances having different magnetic permeabilities.

In general, a characteristic unique to a magnetic substance is a magnetic permeability (or relative magnetic permeability). If magnetic substances having different magnetic permeabilities are combined and the magnetic substances are used as a magnetic path of a coil, the inductance and equivalent resistance of the coil can be changed and thus the Q value of the coil can be changed. Since the thickness of one magnetic substance can be reduced, for example, to the order of a dozen or so microns, a coil unit can be thin-sized even if magnetic substances are used in a stacked manner. This allows increasing the degree of freedom in choosing characteristics of a coil unit while setting the number of turns of a coil wire or the diameter thereof in a range where the coil unit can be downsized or thin-sized. Three or more magnetic substances having different magnetic permeabilities may be combined, as a matter of course.

In the invention, the magnetic permeability of the second magnetic substance may be higher than the magnetic permeability of the first magnetic substance. The equivalent resistance of the coil in a first use condition where the first magnetic substance is used alone as the magnetic path may be smaller than the equivalent resistance of the coil in a second use condition where the second magnetic substance is used alone as the magnetic path. The inductance of the coil in the first use condition may be smaller than the inductance of the coil in the second use condition.

The combination of the first and second magnetic substances having such characteristics can achieve the following characteristics.

First, the coil unit is compared with the first use condition where the first magnetic substance is used alone and the second use condition where the second magnetic substance is used alone. The Q value of the coil unit may be larger than the Q value of the coil in the first use condition and that in the second use condition. That is, the combination of the first and second magnetic substances can realize that the Q value, which is proportional to the ratio (L/R) of the inductance (L) of the coil to the equivalent resistance (R) thereof, becomes larger than that of a coil unit where the first magnetic substance is used alone and that of a coil unit where the second magnetic substance is used alone.

Such a characteristic can be obtained by disposing the magnetic substance at a side adjacent to one surface of the coil and disposing the first magnetic substance between the coil and the second magnetic substance. If the disposition of the first and second magnetic substances is reversed, the Q value tends to decrease; however, the inductance can be improved. In this case, the equivalent resistance becomes relatively large.

If the inductance of the coil unit and the equivalent resistance thereof are compared, the following may turn out. That is, the inductance of the coil may be larger than the inductance of the coil in the first use condition and smaller than the inductance of the coil in the second use condition. The equivalent resistance of the coil may be larger than the equivalent resistance of the coil in the first use condition and smaller than the equivalent resistance of the coil in the second use condition. While the coil unit has the inductance and equivalent resistance each an intermediate value of that of the coil unit in a case where the first magnetic substance is used alone and that of the coil unit in a case where the second magnetic substance is used alone, the Q value of the coil unit according to the aspect of the invention can be increased. The first use condition has an advantage in that the equivalent resistance is small; it has a disadvantage in that the inductance is small. The second use condition has an advantage in that the inductance is large; it has a disadvantage in that the equivalent resistance is large. The coil unit can utilize the advantages of both the first and second use conditions.

Next, the coil unit is compared with a third use condition where two pieces of the first magnetic substance are used in a stacked manner and a fourth use condition where two pieces of the second magnetic substance are used in a stacked manner. The Q value of the coil may be smaller than the Q value of a coil in the third use condition and larger than the Q value of a coil in the fourth use condition. In this case, the inductance of the coil of the coil unit may be larger than that of the coil in the third use condition and smaller than that of the coil in the fourth use condition. Also, the equivalent resistance of the coil of the coil unit may be larger than that of the coil in the third use condition and smaller than that of the coil in the fourth use condition. Therefore, the coil unit can obtain characteristics different from a characteristic in the third use condition and a characteristic in the fourth use condition. The third use condition has an advantage in that the equivalent resistance is small; it has a disadvantage in that the inductance is small. The fourth use condition has an advantage in that the inductance is large; it has a disadvantage in that the equivalent resistance is large. The coil unit can utilize the advantages of both the third and fourth use conditions.

An electronic apparatus according to another aspect of the invention includes the above-mentioned coil unit. Since the coil unit is downsized or thin-sized, the electronic apparatus is downsized or thin-sized as well.

### BRIEF DESCRIPTION OF THE DRAWINGS

The invention will be described with reference to the accompanying drawings, wherein like reference numerals designate like elements.

FIG. 1 is a drawing schematically showing a charger and an electronic apparatus charged by the charger, such as a cell phone.

FIG. 2 is a drawing showing an example of a contactless power transmission method.

FIG. 3 is a drawing schematically showing a coil unit.

FIG. 4 is an exploded perspective view schematically showing the coil unit.

FIG. 5 is a drawing schematically showing a section taken along line V-V of FIG. 3.

FIG. 6 is a sectional view of a coil wire.

FIG. 7 is a graph showing frequency-equivalent resistance characteristics obtained from an experiment.

FIG. 8 is a graph showing frequency-inductance characteristics obtained from the experiment.

FIG. 9 is a table where values at a frequency of 100 kHz extracted from the above-mentioned graphs are organized.

FIG. 10 is a drawing showing another coil unit.

### DETAILED DESCRIPTION OF EMBODIMENTS

Now, a preferred embodiment of the invention will be described in detail. The embodiment described below does not unduly limit the invention as set forth in the appended claims. Also, not all the configurations described in the embodiment are essential as means for solving the above-mentioned problems.

### 1. Charging System

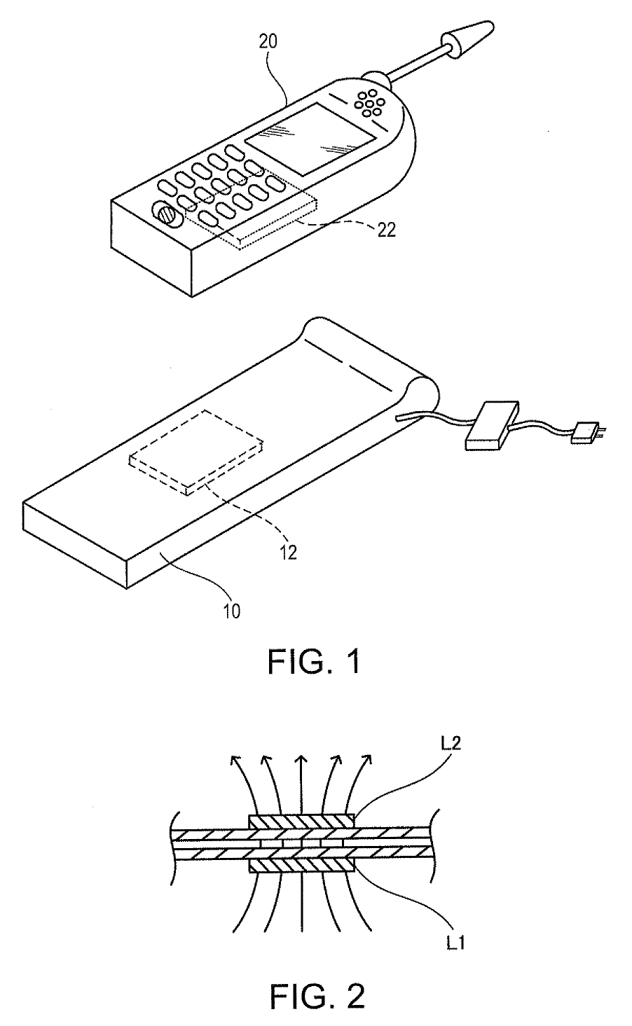

FIG. 1 is a drawing schematically showing a charger 10, which is also an example of an electronic apparatus, and a cell phone 20, which is an example of an electronic apparatus changed by the charger 10. FIG. 1 shows the cell phone 20 to be transversely placed on the charger 10. The cell phone 20 is charged by the charger 10 by means of contactless power transmission using an electromagnetic induction action generated between a coil of a coil unit 12 of the charger 10 and a coil of a coil unit 22 of the cell phone 20.

The charger 10 and cell phone 20 may each have a positioning structure. For example, the charger 10 may have a positioning protrusion protruding out of the outer surface of the case thereof. On the other hand, the cell phone 20 may have a positioning recess on the outer surface of the case thereof. By adopting such positioning, the coil unit 22 of the cell phone 20 is at least disposed in a position opposed to the coil unit 12 of the charger 10.

As schematically shown in FIG. 2, power is transmitted from the charger 10 to the cell phone 20 by electromagnetically coupling a primary coil L1 (power transmission coil) included in the charger 10 and a secondary coil L2 (power reception coil) included in the cell phone 20 and thus forming a power transmission transformer. This realizes contactless power transmission. Note that FIG. 2 shows an example of electromagnetic coupling between the primary coil L1 and secondary coil L2 and that another type electromagnetic coupling where magnetic force lines are formed in a way different from that in FIG. 2 may be adopted.

### 2. Coil Unit of Cell Phone 20

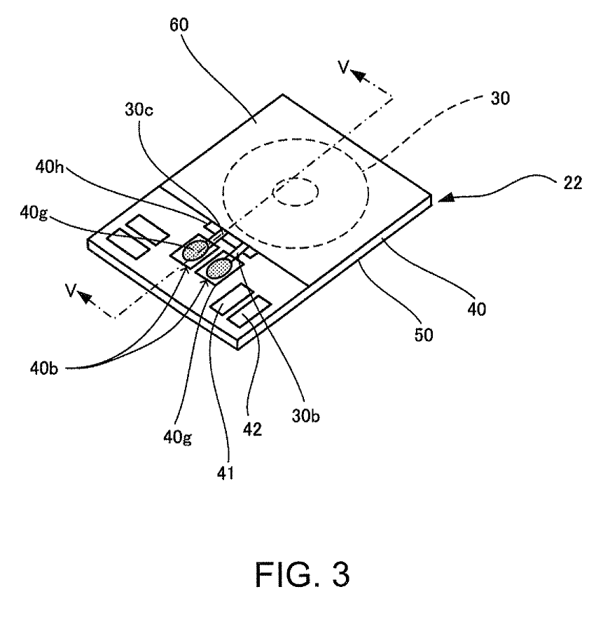

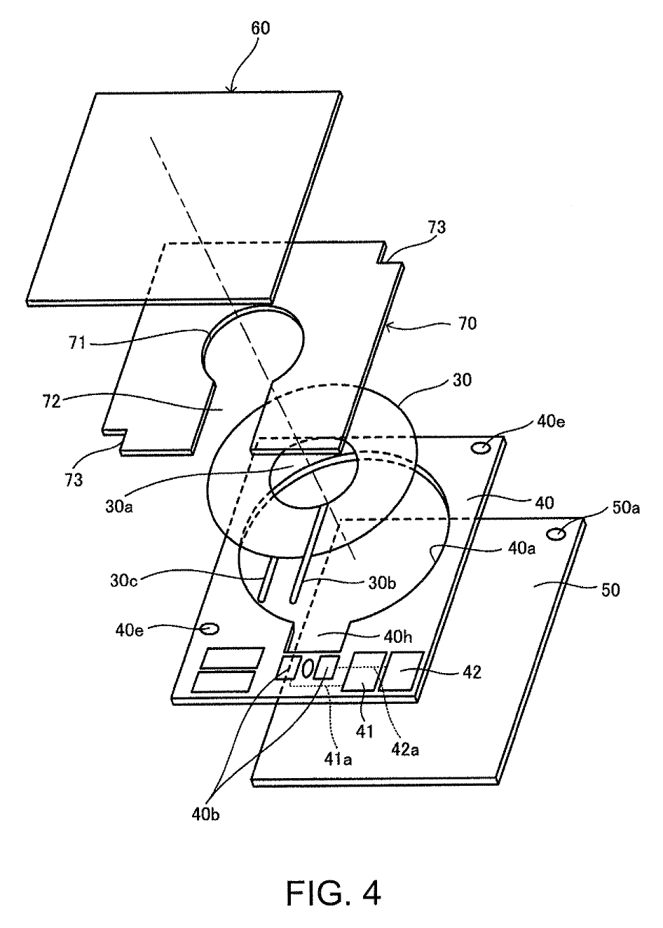

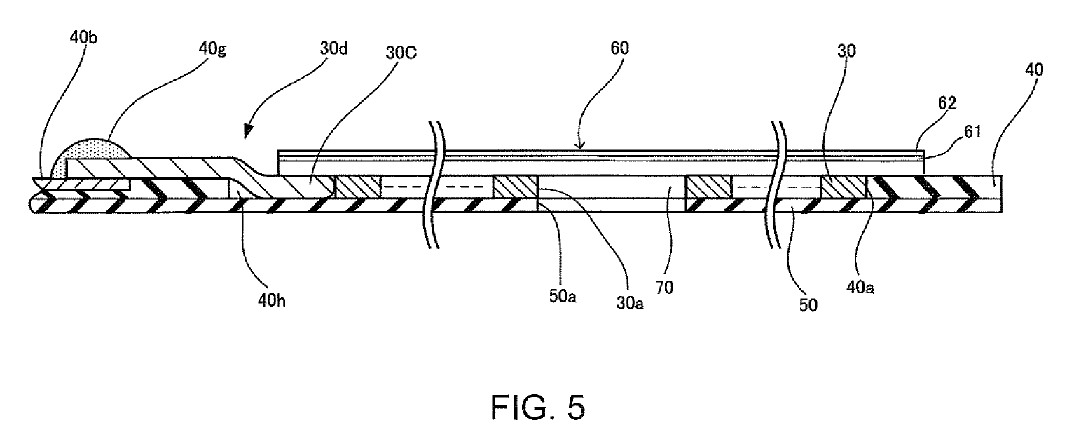

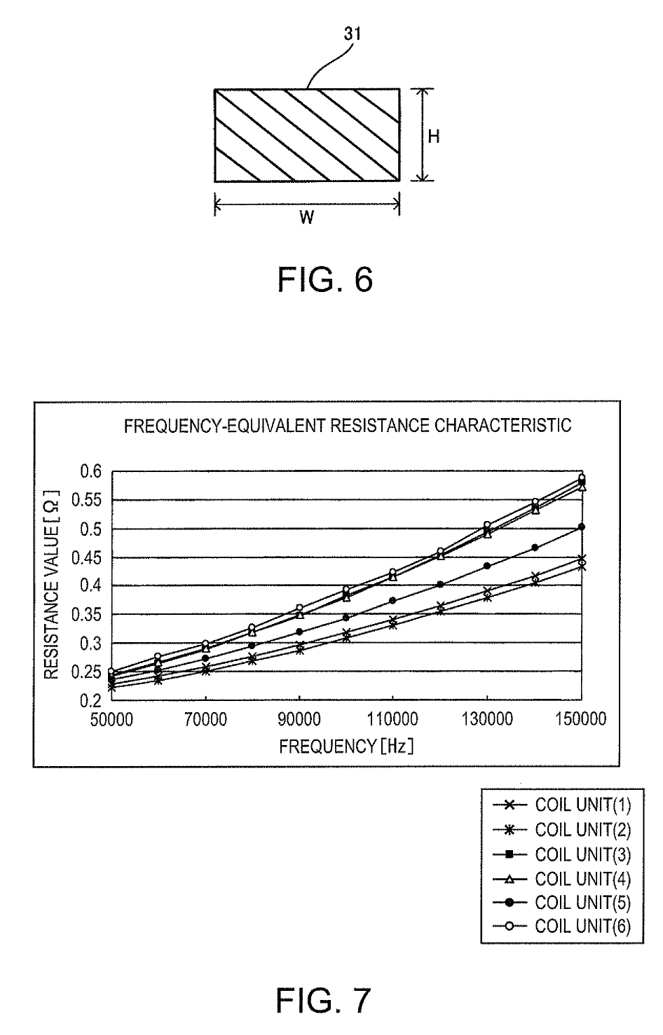

FIG. 3 is a drawing schematically showing the coil unit 22 of the cell phone 20. FIG. 4 is an exploded perspective view schematically showing the coil unit 22 of the cell phone 20. FIGS. 3 and 4 are drawings showing the non-transmission surface of the coil unit 22 opposite to the transmission surface thereof. The transmission surfaces refer to the respective surfaces of the coil unit 22 and the coil unit 12 opposed to each other in FIG. 1 and the non-transmission surfaces refer to the respective surfaces opposite to the transmission surfaces of the coil unit 12 and coil unit 22. FIG. 5 is a drawing schematically showing a section taken along line V-V of FIG. 3. FIG. 6 is a sectional view of a coil wire and shows a form in which the coil unit 22 and a control unit 100 are electrically coupled.

The coil unit 22 includes a coil 30 and a magnetic substance 60 as smallest elements. In this embodiment, the coil unit 22 may additionally include a wiring substrate 40 for maintaining the shape the coil unit 22. Also, a coil housing 40a may be formed on the wiring substrate 40 so that the transmission surface of the coil 30 is positioned on the back surface of the wiring substrate 40. The coil housing 40a is a hole that penetrates the wiring substrate 40 in the thickness direction. Also, in this embodiment, a protection sheet 50 for protecting the transmission surface of the coil 30 may be provided on the back surface of the wiring substrate 40 shown in FIG. 4.

The wiring substrate 40 is provided with connection terminals 40b to which the both ends of the coil 30 are connected, external connection terminals 41 and 42, and wiring patterns 41a and 42a. The external connection terminals 41 and 42 are terminals used when connecting the coil unit 22 to an external apparatus such as the control unit 100 (not shown). The wiring patterns 41a and 42a connect between the contact terminal 40b of the coil 30 and external connection terminals 41 and 42. In this embodiment, the wiring patterns 41a and 42a are formed, for example, on the back surface (a surface on which none of the terminals 40b, 41a, and 42a is formed) of the wiring substrate 40 shown in FIG. 4 and connected to the terminals 40b, 41a, and 42a via a through-hole. The wiring patterns 41a and 42a may be provided on the front surface of the wiring substrate 40.

The coil 30 is a flat coil. The magnetic substance 60 takes the shape of a sheet or a plate. Hereafter, a sheet-shaped magnetic substance will be also referred to as a magnetic sheet. The magnetic sheet 60 is provided in such a manner that it is opposed to the non-transmission surface of the flat coil 30. In this embodiment, the magnetic sheet 60 is bonded to the non-transmission surface of the flat coil 30 as well as to the wiring substrate 40 with a spacer 70 (for example, double-sided tape) therebetween.

The flat coil 30 is not limited to any particular coil if it is a flat coil. For example, an air-core coil formed by winding a single-wire or multi-wire, coated coil wire on a plane may be used. In this embodiment, a coil formed by winding a single-wire coil wire 31, whose section is a rectangle with a width W and a height H, on a plane as shown in FIG. 6 is used. Hereafter, the coil unit 22 according to this embodiment will be described taking the flat coil 30 having an air-core 30a (see FIGS. 4, 5) as an example.

As described above, the flat coil 30 is housed in the coil housing 40a provided on the wiring substrate 40. This allows slimming down the coil unit 22 by the thickness (H (see FIG. 6)) of the flat coil housed in the coil housing 40a. This also makes it easy to make the transmission surface of the flat coil 30 flush with the adjacent surface. Actually, in this embodiment, no recesses or protrusions are formed on the protection sheet 50. Also, the coil housing 40a has a shape corresponding the external shape of the flat coil 30. Thus, if the flat coil 30 is only housed in the coil housing 40a, the flat coil 30 is positioned in the wiring substrate 40. This facilitates positioning.

As shown in FIG. 4, the wiring substrate 40 has multiple positioning holes 40e, and the protection sheet 50 has multiple positioning holes 50a (only one is shown in FIG. 4).

The coil unit 22 may be assembled, for example, using fixtures. The pins of the fixtures are passed through the positioning holes 50a of the protection sheet 50 and the positioning holes 40e of the wiring substrate 40, and then the protection sheet 50 having a single-sided tape and wiring substrate 40 are laminated. Next, the coil 30 is disposed in the coil housing 40a of the wiring substrate 40 so that the coil 30 is bonded to the protection sheet 50. Then, the magnetic sheet 60 is bonded to the wiring substrate 40 with the spacer 70 therebetween in such a manner that the spacer 70 covers the coil 30. Finally, both ends of the flat coil 30 are soldered to the connection terminals 40b of the wiring substrate 40. This completes the coil unit 22. While the protection sheet 50 is a sheet for protecting at least the fiat coil 30, it covers both the transmission surfaces of the wiring substrate 40 and coil 30 in this embodiment. The protection sheet 50 may have a hole in a position corresponding to the air-core 30a.

The flat coil 30 includes a coil inner end drawing line 30b for drawing the inner end of the coil and a coil outer end drawing line 30c for drawing the outer end thereof. As shown in FIG. 4, the coil inner end drawing line 30b is preferably drawn from the non-transmission surface of the flat coil 30. This prevents the coil inner end drawing line 30b from forming protrusions on the transmission surface. This makes the transmission surface flat, as well as reduces the distance between the respective transmission surfaces of the primary coil L1 and secondary coil L2 shown in FIG. 2. As a result, the transmission efficiency is increased.

The wiring substrate 40 has a drawing line housing 40h connecting with the coil housing 40a (see FIGS. 3 to 5). The drawing line housing 40h is intended to house the coil inner end drawing line 30b of the flat coil 30 and coil outer end drawing line 30c thereof. While only the coil outer end drawing line 30c is shown in FIG. 5, the same goes for the coil inner end drawing line 30b. Since the drawing line housing 40h is provided and the drawing lines 30b and 30c are housed therein, that area is slimmed down by the thicknesses of the drawing lines 30b and 30c. Also, as shown in FIG. 4, the drawing lines 30b and 30c (only the drawing line 30c is shown in FIG. 5) are bent relatively gently and then go up onto the wiring substrate 40. This reduces wire breaks.

The coil inner end drawing line 30b and coil outer end drawing line 30c are drawn to the contact terminal 40b serving as the connection terminal of the coil 30 and then electrically connected to a pattern on the wiring substrate 40 using solder 40g as shown in FIGS. 3 and 5. The contact terminal 40b is provided on the non-transmission surface (viewer side of FIGS. 3 and 4) of the wiring substrate 40. While the coil inner end drawing line 30b and coil outer end drawing line 30c are housed in the drawing line housing 40h of the wiring substrate 40 as shown in FIG. 5, a bend 30d is made on each of these drawing lines so that these drawing lines go up onto the wiring substrate 40.

Generally, in a power transmission system, a secondary battery is disposed on the non-transmission surface. As for a lithium ion secondary battery or a lithium polymer secondary battery typically used in cell phones and MP3 players in recent years, the temperature thereof during charging is required to be about 45° C. or less due to the physical properties thereof. If the battery is charged at a temperature exceeding the temperature, a gas may occur inside the battery, causing the degradation of the battery and, in the worst case, the explosion thereof. Therefore, it is necessary to reduce the heating of the battery during charging. Use of the protection sheet 50 as a heat dissipation path reduces an increase in the temperature on the non-transmission surface,

Also, since the inner terminal of the flat coil 30 is drawn from the non-transmission surface, the transmission surface becomes flat. This advantageously increases the adhesiveness between the flat coil 30 and protection sheet (heat dissipation sheet) 50 to reduce the thermal contact resistance to facilitate heat dissipation.

In this embodiment, the protection sheet 50 has an external shape conforming to that of the wiring substrate 40, but not limited thereto. The shape (area) of the protection sheet 50 may be formed so that the area of the transmission surface of the coil unit in contact with the internal shape (area) of an external case is maximized. This further enhances the heat dissipation effect.

The spacer 70 has a hole 71 corresponding to the air-core 30a of the flat coil 30, a notch 72 that connects with the hole 71 and corresponds to the drawing line housing 40h of the wiring substrate 40, and a notch 73 corresponding to the positioning hole 40e of the wiring substrate 40. The disposition of the notch 72 prevents (at least reduces) recesses and protrusions formed by the thicknesses of the drawing lines 30b and 30c of the flat coil 30 from affecting the magnetic sheet 60. Also, the disposition of the notch 73 makes it easy to perform positioning between the wiring substrate 40 and protection sheet 50 using the above-mentioned positioning holes 40e and 50a.

The magnetic sheet 60 has functions of receiving magnetic flux from the flat coil 30 and increasing the inductance of the flat coil 30. The material of the magnetic sheet may be various magnetic materials such as a soft magnetic material, a ferrite soft magnetic material, and a metal soft magnetic material. However, if only one magnetic sheet (magnetic substance) is provided for the coil 30, the coil characteristics with respect to this contactless power transmission largely depend on the characteristics of the one magnetic sheet.

In this embodiment, in order to increase the degree of freedom in choosing the coil characteristics that cannot be chosen with one magnetic sheet, two magnetic sheets, magnetic sheets 61 and 62, having different characteristics, particularly, different magnetic permeabilities are provided (magnetic sheets 61 and 62 constitute the magnetic sheet 60 as a multilayer body) in layers with respect to the coil 30 as shown in FIG. 5. By doing so, the coil unit 22 can obtain different characteristics unlike a coil unit 22 where one magnetic sheet is used alone or a coil unit 22 where two magnetic sheets having identical characteristics are used. The first magnetic sheet 61 and second magnetic sheet 62 are laminated by bonding these magnetic sheets together, for example, using a double-sided tape.

3. Example Experimental with Respect to Primary Coil Unit

The coil 30 used in an experiment was formed by winding the coil wire 31 having a section with the width W of 0.46 mm and the height (thickness) H of 0.23 mm as shown in FIG. 6. When an alternating current of 1 mA at a frequency of 100 kHz was passed through the coil 30, the coil 30 alone showed an inductance of 6.366 μH and a resistance of 0.234Ω. By combining at least one of the magnetic sheets 61 and 62 having different characteristics to the flat coil 30 as described later and bonding the magnetic sheet and the flat coil 30 together, six types of coil units (1) to (6) were prepared.

A sheet A and a sheet B were used as magnetic sheets having different characteristics, particularly, different magnetic permeabilities. The relative magnetic permeability of the sheet A at an alternating frequency of 100 KHz is smaller than that of the sheet B. The sheets A and B are made of, for example, an amorphous magnetic substance.

The coil units (1) to (6) used in the experiment are as follows.

(1) A coil unit where a single sheet A is bonded to the non-transmission surface of the coil 30

(2) A coil unit where two laminated sheets A are bonded to the non-transmission surface of the coil 30, that is, a coil unit where both magnetic sheets 61 and 62 are used as sheets A

(3) A coil unit where a single sheet B is bonded to the non-transmission surface of the coil 30

(4) A coil unit where two laminated sheets B are bonded to the non-transmission surface of the coil 30, that is, a coil unit where both magnetic sheets 61 and 62 are used as sheets B

(5) A coil unit where a sheet A and a sheet B are sequentially bonded to the non-transmission surface of the coil 30, that is, a coil unit where a sheet A is used as a sheet 61 and a sheet B is used as a sheet 62

(6) A coil unit where a sheet B and a sheet A are sequentially bonded to the non-transmission surface of the coil 30, that is, a coil unit where a sheet B is used as a sheet 61 and a sheet A is used as a sheet 62

The coil units (5) and (6) are units corresponding to this embodiment. In particular, the coil unit (5) is a coil unit used in this apparatus. As comparative examples, the coil unit (1) is a first use condition, the coil unit (3) is a second use condition, the coil unit (2) is a third use condition, and the coil unit (4) is a fourth use condition.

In the experiment, an alternating current of 1 mA was passed through each of the above-mentioned coil units (1) to (6) while changing the frequency, and then the equivalent electric resistance (Ω) and self-inductance (μH) at different frequencies were measured. The frequency was changed from 50 kHz to 150 kHz at intervals of 10 kHz.

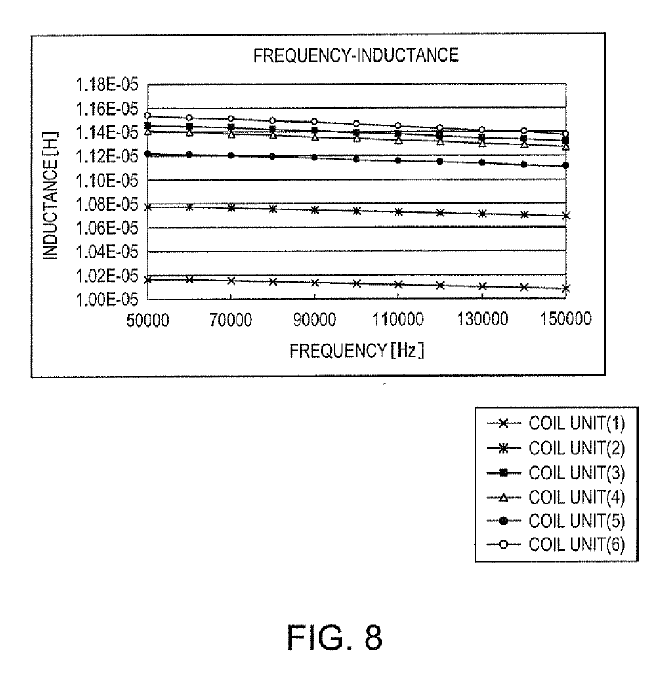

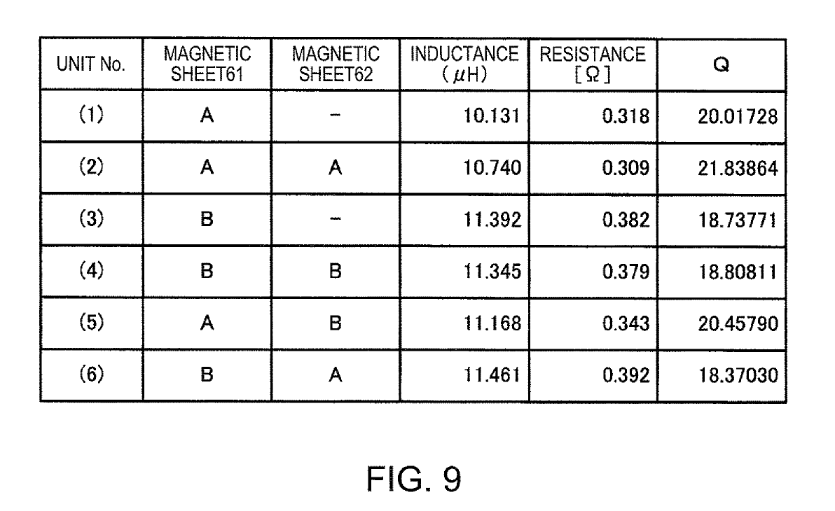

FIG. 7 is a graph showing frequency-equivalent resistance characteristics obtained from the above-mentioned experiment. FIG. 8 is a graph showing frequency-inductance characteristics. FIG. 9 is a table where the values at a frequency of 100 kHz extracted from these graphs are organized. In FIGS. 7 and 8, “x” indicates a measurement result of the coil unit (1), “*” indicates that of the coil unit (2), “solid ▪” indicates that of the coil unit (3), “triangle” indicates that of the coil unit (4), “” indicates that of the coil unit (5), and “∘” indicates that of the coil unit (6). In FIG. 9, the Q values are values obtained as inductance/resistance (Ω·L/R) at the measurement frequency.

From the experiment, the following turned out:

(a) If the sheet A and sheet B are compared as single units, the equivalent resistance (0.318Ω) of the coil of the coil unit (1) in the first use condition where the single sheet A is used as a magnetic path of the coil is smaller than the equivalent resistance (0.382Ω) of the coil of the coil unit (3) in the second use condition where the single sheet B is used as a magnetic path thereof. Also, the inductance (10.131 μ) of the coil of the coil unit (1) is smaller than the inductance (11.392 μH) of the coil of the coil unit (3).

As for the coil unit (5) of the coil units (5) and (6) according to this embodiment, the Q value (20.4579) of the coil is larger than the Q value (20.01728) of the coil of the coil unit (1) in the first use condition and the Q value (18.73771) of the coil of the coil unit (3) in the second use condition. This is an advantage obtained by combining the sheet A and sheet B. It is understood that since the Q value of the coil proportionate to the ratio (L/R) of the inductance L to equivalent resistance R is large, a large inductance is secured and the equivalent resistance R is reduced and thus the characteristics of the coil are improved.

The above-mentioned advantage of (b) depends on the order of the lamination of the sheets A and B with respect to the coil and is an advantage specific to the coil unit (5) where the sheet A is positioned between the coil and sheet B. Unlike this, the Q value (18.3703) of the coil of the coil unit (6) where the sheet B is disposed between the coil and sheet A is smaller than the Q value (20.01728) of the coil unit (1) in the first use condition and the Q value (18.73771) of the coil of the coil unit (3) in the second use condition. However, the coil unit (6) indicates the largest inductance (11.461). Therefore, the coil unit (6) is used if greater importance is placed on the inductance. The coil unit (6) also indicates the largest equivalent resistance (0.392).

(d) The inductance (11.168) of the coil of the coil unit (5) is larger than the inductance (10.131) of the coil unit (1) in the first use condition and is smaller than the inductance (11.392) of the coil unit (3) in the second use condition.

(e) The equivalent resistance (0.343) of the coil of the coil unit (5) is larger than the equivalent resistance (0.318) of the coil unit (1) in the first use condition and is smaller than the equivalent resistance (0.382) of the coil unit (3) in the second use condition. From the above-mentioned (d) and (e), it is understood that the inductance and equivalent resistance of the coil unit (5) cording to this embodiment are both an intermediate value between those of the coil units (1) and (3) where the sheet A or sheet B is used alone and thus an increase in equivalent resistance is reduced while a relatively high inductance is secured.

(f) Next, the coil unit (5) according to this embodiment is compared with the coil unit (2) where two sheets A are laminated and the coil unit (4) where two sheets B are laminated. The Q value (20.4579) of the coil of the coil unit (5) is smaller than the Q value (21.83864) of the coil unit (2) where two sheets A are laminated in the third use condition and is larger than the Q value (18.80811) of the coil of the coil unit (4) where two sheets B are laminated in the fourth use condition. However, it is understood that the Q value of the coil of the coil unit (5) is closer to the Q value of the coil of the coil unit (2) indicating the largest value. Since the Q value of the coil is proportionate to the ratio (L/R) of the inductance L to equivalent resistance R, the above-mentioned points are supported by findings (g) and (h) below obtained by comparing the inductance with the equivalent resistance.

(g) The inductance (11.168) of the coil of the coil unit (5) is larger than the inductance (10.740) of the coil unit (2) in the third use condition and is smaller than the inductance (11.345) of the coil unit (4) in the fourth use condition. However, it is understood that the inductance of the coil of the coil unit (5) is closer to the large inductance of the coil unit (4).

(h) The equivalent resistance (0.343) of the coil of the coil unit (5) is larger than the equivalent resistance (0.309) of the coil unit (2) in the third use condition and is smaller than the equivalent resistance (0.379) of the coil of the coil unit (4) in the fourth use condition. The equivalent resistance of the coil of the coil unit (5) is approximately an intermediate value between those of the coil unit (2) and (4)

(i) In conclusion, it is understood that the coil units (5) and (6) including the two magnetic sheets, magnetic sheets 61 and 62, having different characteristics, particularly, different magnetic permeabilities can obtain characteristics different from those of the coil units (1) and (3) including a single magnetic substance and those of the coil units (2) and (4) including laminated magnetic substances of same type and thus can obtain the degree of freedom in choosing the characteristics. This allows bringing the equivalent resistance or inductance close to a designed value without having to change the number of turns of the coil or the wire diameter thereof. In particular, as for the coil unit (5), the Q value of the coil is relatively high; therefore, the transmission efficiency can be improved by reducing the equivalent resistance and reducing a reduction in inductance. The above-mentioned tendency is not a tendency only at a frequency of 100 kHz; from FIGS. 8 and 9, it is understood that a similar tendency exists in almost the whole measurement frequency range.

As another advantage, the sheet B also has a high magnetic shield property, since it has a high magnetic permeability. Therefore, in the coil unit (5), magnetic flux leaking from the first magnetic substance (sheet A) closer to the coil 30 is received by the second magnetic substance 62 (sheet B) so that the magnetic flux is prevented from leaking out toward the non-transmission surface of the second magnetic substance 62. Therefore, a magnetic shield plate does not always need to be disposed on the magnetic substance 62 in an overlapped manner.

### 4. Modifications

While this embodiment has been described in detail, it will be understood by those skilled in the art that various modifications can be made thereto without substantively departing from the novel features and advantages of the invention. Therefore, such modifications fall within the scope of the invention. For example, terms described at least once in conjunction with broader or synonymous different terms in this specification or appended drawings can be replaced with the different terms in any part of the specification or drawings.

While the above-mentioned embodiment is applied to the coil unit 22 of the cell phone 20 that is required to reduce the size and weight, the embodiment may be applied to the coil unit 12 of the charger 10.

The above-mentioned embodiment is applicable to all electronic apparatuses that transmit power or signals. For example, the embodiment is applicable to apparatuses to be charged and including a secondary battery, such as a wristwatch, an electric toothbrush, an electric shaver, a cordless phone, a personal handy phone, a mobile personal computer, a PDA (personal digital assistants), and an electric bicycle, and chargers thereof.

Also, a coil unit to which the invention is applied is not limited to a flat coil that is wound in a spiral fashion and has an air-core, and may be other various coils.

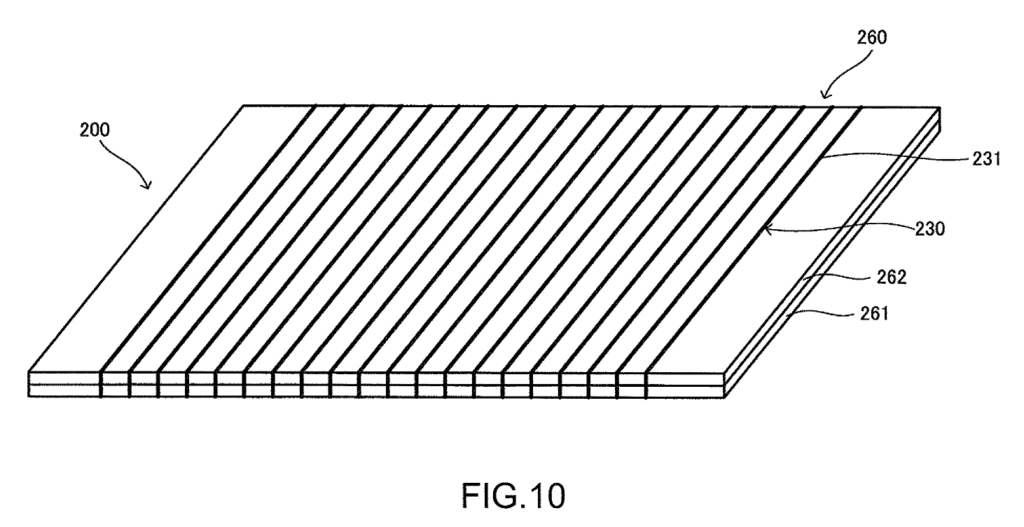

FIG. 10 shows a coil unit 200 of a type different from that of the above-mentioned embodiment. The coil unit 200 includes, for example, a coil 230 formed by wiring a coil wire 231 around a flat magnetic substance core 260. When an alternating current is passed through the coil wire 231 of the coil unit 200, a magnetic path is formed on the magnetic substance core 260 and lines of magnetic flux line are formed in parallel with the magnetic substance core 260. Even if the coil apparatus 200 is used as the primary coil L1, contactless power transmission is achieved by magnetic coupling with the secondary coil L2. The magnetic substance core 260 is formed by a first magnetic substance 261 and a second magnetic substance 262. Since the magnetic substance core 260 also forms a magnetic path of the coil like the magnetic substance 60 according to the above-mentioned embodiment, the first magnetic substance 261 and second magnetic substance 262 are formed by the first magnetic substance 61 and second magnetic substance 62 having the above-mentioned characteristics.

That is, the invention is not limited to a coil unit having a magnetic substance on a surface of a coil and may be a coil unit using a magnetic substance as the core of a coil. Also, the combination of a coil and a magnetic substance for forming a magnetic path of the coil is not limited to the above-mentioned combination and coils having other various shapes and magnetic substances having other various shapes may be combined. Also, the invention does not always need to be a flat, thin coil unit.

1. A coil unit, comprising:
a coil; and
a magnetic substance that receives magnetic lines of force generated by the coil, the magnetic substance including:
a first magnetic substance having a first magnetic permeability; and
a second magnetic substance having a second magnetic permeability.

2. The coil unit according to claim 1,
the first magnetic substance and the second magnetic substance being laminated.

3. The coil unit according to claim 1,
the coil having a first equivalent resistance, a first inductance, and a first Q value.

4. The coil unit according to claim 3,
the second magnetic permeability being higher than the first magnetic permeability, and
a second equivalent resistance being smaller than a third equivalent resistance, the second equivalent resistance being an equivalent resistance of the coil in a first use condition in which the first magnetic substance is disposed alone, the third equivalent resistance being an equivalent resistance of the coil in a second use condition in which the second magnetic substance is disposed alone, and a second inductance being smaller than a third inductance, the second inductance being an inductance of the coil in the first use condition, the third inductance being an inductance of the coil in the second use condition.

5. The coil unit according to claim 4,
the first Q value being larger than a second Q value and a third Q value, the second Q value being a Q value of the coil in the first use condition, the third Q value being a Q value of the coil in the second use condition.

6. The coil unit according to claim 5,
the magnetic substance being disposed at a side adjacent to one surface of the coil, and the first magnetic substance being disposed between the coil and the second magnetic substance.

7. The coil unit according to claim 6,
the first inductance being larger than the second inductance and smaller than the third inductance.

8. The coil unit according to claim 4,
the first equivalent resistance being larger than the second equivalent resistance and smaller than the third equivalent resistance.

9. The coil unit according to claim 4,
the first Q value being smaller than a fourth Q value and larger than a fifth Q value, the fourth Q value being a Q value of the coil in a third use condition in which two pieces of the first magnetic substance are disposed in a stacked manner, the fifth Q value being a Q value of the coil in a fourth use condition in which two pieces of the second magnetic substance are disposed in a stacked manner.

10. The coil unit according to claim 9,
the first inductance being larger than a fourth inductance and smaller than a fifth inductance, the fourth inductance being an inductance of the coil in the third use condition, the fifth inductance being an inductance of the coil in the fourth use condition.

11. The coil unit according to claim 9,
the first equivalent resistance being larger than the fourth equivalent resistance and smaller than the fifth equivalent resistance.

12. An electronic apparatus, comprising
the coil unit according to claim 1.

13-20. (canceled)
